(19) United States
(12) Patent Application Publication
(10) Pub. No.: US 2004/0130733 A1
(43) Pub. Date: Jul. 8, 2004

(54) Image formation apparatus, image formation method, and program

(75) Inventors: Masao Morita, Kanagawa (JP); Masanori Sekino, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/737,914

(22) Filed: Dec. 18, 2003

(30) Foreign Application Priority Data
Dec. 19, 2002 (JP) 2002-367900

(51) Int. Cl. G06T 3/40; G06T 9/00; H04N 1/393

(52) U.S. Cl. 358/1.2; 382/232; 382/238; 382/299; 358/451

(57) ABSTRACT

A printer scales up a pixel group to match the resolution of an input image with that of an output image. Further, if it is necessary to compress and retain image data during image formation processing, the printer performs preprocessing forming a part of compression processing and then performs scale-up processing of pixel data, thereby making it possible to decrease the processing load of the preprocessing and further provide a high compression ratio.

### BACKGROUND OF THE INVENTION

1. Field of the Invention

This invention relates to an image processing apparatus for performing scale-up processing and coding processing of pixel groups forming an image.

2. Description of the Related Art

To form image data, the output resolution of an image formation apparatus, such as a printer or a monitor, and the input resolution of image data input to the apparatus may differ, and the resolution of the image data needs to be converted into the output resolution. For example, an image on a web page is about 72 to 100 dots/inch matched with the resolution of a monitor, while the output resolution of a printer is about 300 to 2400 dots/inch. To output the image on a web page on the printer, the pixel data needs to be interpolated for being matched with the output resolution of the printer.

As a resolution conversion method, an interpolation method based on the peripheral pixels in the proximity of an attention pixel is available. For example, in Nearest Neighbor method, the pixel data is interpolated based on the pixel value at the nearest neighbor position and the image size is changed.

Since the image formation apparatus such as a printer involves an upper limit on the available memory amount or bus band, the image data needs to be retained and transmitted in a compression state. Various coding methods are proposed as means for compressing the image data (for example, JP-A-9-224253 and JP-A-10-294670).

### SUMMARY OF THE INVENTION

It is therefore an object of the invention to provide an image processing apparatus, an image processing method, and a program for changing the resolution of an image and further compressing image data efficiently.

To the end, according to the invention, there is provided an image processing apparatus having a coding section for coding image data of a pixel group including a predetermined number of pixels; and a scale-up section for scaling up the pixel group based on the image data coded by the coding section.

According to the invention, there is provided an image processing apparatus having a preprocessing section for performing preprocessing for coding for image data of a pixel group including a predetermined number of pixels; a scale-up section for scaling up the pixel group based on the image data subjected to the preprocessing by the preprocessing section; and a coding section for coding the image data of the pixel group scaled up by the scale-up section.

Preferably, the preprocessing section includes a pixel value change section for changing the pixel value of an attention pixel on which attention is focused as the processing target based on the pixel value of the attention pixel and the pixel values of peripheral pixels of the attention pixel, the scale-up section scales up the pixel group based on the pixel value provided by the pixel value change section, and the coding section codes the image data of the pixel group scaled up by the scale-up section.

Preferably, the preprocessing section further includes a distribution section for distributing the change amount of the pixel value provided by the pixel value change section to another pixel, the scale-up section accepts the pixel value distributed by the distribution section and further scales up the pixel group based on the pixel value provided by the pixel value change section, and the coding section codes the image data of the pixel group scaled up by the scale-up section.

Preferably, to code the image data of the attention pixel, the preprocessing section references the pixel value of the peripheral pixel of the attention pixel and coverts the pixel value of the attention pixel into data to be coded, and the coding section codes the data to be coded, provided by the preprocessing section.

Preferably, the direction in which the scale-up section scales up the pixel group matches the referencing direction of the coding section.

According to the invention, there is provided an image processing apparatus having a scale-up section for scaling up a pixel group including a predetermined number of pixels; a pixel value change section for changing the pixel values of the pixel group; a distribution section for distributing the change amount of the pixel value provided by the pixel value change section to another pixel group; and a coding section for accepting the pixel value distributed by the distribution section and coding the image data of the pixel group based on the pixel values provided by the pixel value change section, wherein the scale-up section scales up the pixel group to which the pixel values have been distributed by the distribution section at least in one direction.

Preferably, the image processing apparatus further has an input section; and an acquisition section for acquiring the image data corresponding to one row of a pixel group forming a part of an image as a processing unit from image data input through the input section, wherein the coding section codes the image data for each processing unit acquired by the acquisition section, and wherein the scale-up section scales up the pixel group for each processing unit acquired by the acquisition section.

Preferably, the image processing apparatus further has an output section (an image formation section, a communication section, etc.) for decoding the image data coded by the coding section and outputting the provided data.

According to the invention, there is provided image processing method having the steps of coding image data of a pixel group including a predetermined number of pixels by a computer; and scaling up the pixel group by the computer based on the coded image data.

According to the invention, there is provided, in an image processing apparatus including a computer, a program for causing the computer of the image processing apparatus to execute the steps of coding image data of a pixel group including a predetermined number of pixels; and scaling up the pixel group based on the coded image data.

The resolution is an index indicating the quantity of pixels making up an image; for example, it is the number of pixels per unit length (per inch, etc.) in an image.

The preprocessing refers to processing performed before coding processing; for example, it includes processing of changing the nature of an image, processing of counting the successive number of occurrences of the same pixel value, processing of changing pixel data to prediction information for prediction coding, and the like.

The image data is the data required for forming an image; for example, it includes the data indicating the pixel value of each pixel, the data indicating the change amount of the pixel value of each pixel, the data specifying the pixel value prediction method, the code data provided by coding the data, and the like.

### BRIEF DESCRIPTION OF THE DRAWINGS

These and other objects and advantages of this invention will become more fully apparent from the following detailed description taken with the accompanying drawings in which:

FIG. 1 is a drawing to illustrate the hardware configuration of a printer 2 (image formation apparatus) incorporating an image processing method according to the invention centering on a controller 20;

FIG. 2 is a diagram to show the configuration of an image formation program 5 executed by the controller 20 (FIG. 1) for realizing the image processing method according to the invention;

FIG. 3 is a diagram to describe the configuration of a preprocessing section 520 in more detail;

FIG. 4 is a flowchart to show first operation (S10) of the printer 2 (image formation program 5);

FIG. 5 is a drawing to describe change in pixel data as preprocessing and scale-up processing shown in the flowchart of FIG. 4 are performed;

FIG. 6 is a flowchart to show second operation (S12) of the printer 2 (image formation program 5);

FIG. 7 is a drawing to describe change in pixel data in preprocessing and scale-up processing shown in FIG. 6; and

FIG. 8 is a drawing to describe change in pixel data when preprocessing is performed to execute prediction coding after scale-up processing is performed for image data.

### DETAILED DESCRIPTION OF THE PREFERRED EMBODIMENTS

First, to aid in understanding the invention, the background of the invention will be discussed.

If the resolution is raised with pixels interpolated into an image, the data size of the image data becomes large and the necessity for compression still more intensifies. The compression processing is made up of preprocessing of handling image data before coding and coding processing of coding the image data subjected to the preprocessing. Since the image data to which the compression processing is applied becomes large, the loads of the preprocessing and the coding processing also grow.

The growing process of the processing loads will be discussed with an example of resolution conversion processing and compression processing.

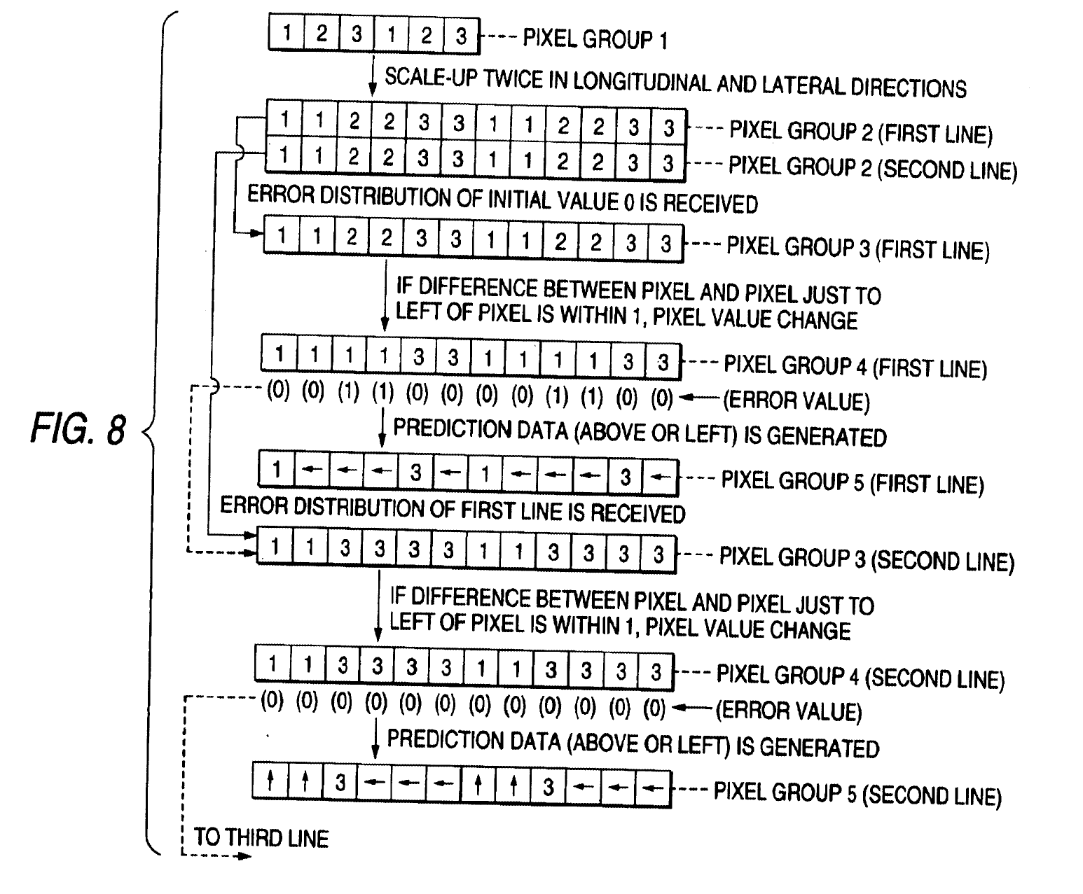

FIG. 8 illustrates pixel data subjected to preprocessing to perform scale-up processing for image data and performing prediction coding. A part of the preprocessing and the coding processing are executed by a method disclosed in JP-A-9-224253 or JP-A-10-294670. That is, in the preprocessing in the example, to raise the prediction hit rate of prediction coding and lessen the code amount, if the difference between the true pixel value and the prediction value is within 1, the true pixel value is converted into the prediction value and if the same prediction values are successive, the successive number of the same prediction values is counted and the values are collected as coded data. In the prediction coding in the example, coded data generated by the preprocessing (data for determining the prediction value, the successive number of prediction values, the pixel values, etc.) is converted into code.

In the figure, “pixel group 1” is pixels of the first line of original image data, and the numeric values in “pixel group 1” indicate the pixel values of the pixels of the first line. Pixels are interpolated into “pixel group 1” in a longitudinal direction and a lateral direction (line direction) by Nearest Neighbor method and is scaled up to the double size to form “pixel group 2.”

To each of the pixel values of the first and second lines of “pixel group 2,” an error value (described later) occurring on the line just above the pixel value is added to form the first and second lines of “pixel group 3.”

If the difference between each pixel value of the first and second lines of “pixel group 3” and the pixel value (prediction value) just to the left of the pixel value is within 1, the pixel value of the attention pixel is changed to the prediction value to form the first and second lines of “pixel group 4.” As this change is made, an error occurs between the true pixel value and the prediction value, and the value of this error is added to the next line. For example, the error value occurring on the first line is added to each pixel value of the second line.

Whether or not each pixel of the first and second lines of “pixel group 4” matches the pixel just above or just to the left of the pixel is determined. If they match, the pixel is converted into the prediction data indicating the position of the match pixel (in the example, arrow symbol in the figure) to form the first and second lines of “pixel group 5.” If the pixel does not match the pixel just above or just to the left of the pixel, the pixel value itself is adopted as prediction data (in the example, digit in the figure).

“Pixel group 5” in the example is coded using two-bit code indicating prediction value match or mismatch (“00”=“match just to left,” “01”=“match just above, “11”=“mismatch”) and four-bit code indicating the successive number or the pixel value. For example, the second line of “pixel group 5” is coded as follows:

“01, 0010, 11, 0011, 00, 0011, . . . ”

Thus, if the pixel data of one line becomes two lines as interpolation processing (scale-up processing) is performed, the preprocessing and the coding processing need to be performed for the pixel data of the two lines, growing the processing load. Before the preprocessing is performed, each pixel value of the second line generated by the scale-up processing is similar to each pixel value of the first line and a high compression ratio can be expected, but the similarity is destroyed because of error value distribution in the preprocessing, etc.

Then, an image processing method according to the invention makes it possible to decrease the processing load by performing scale-up processing after preprocessing. Further, since the pixel data (second line) generated by the scale-up processing is similar to the original image data (first line), at least a part of the preprocessing (preferably, pixel value change processing) is performed before the scale-up processing, whereby coding can be accomplished with the similarity held and it is made possible to achieve a high compression ratio.

An embodiment of the invention will be discussed.

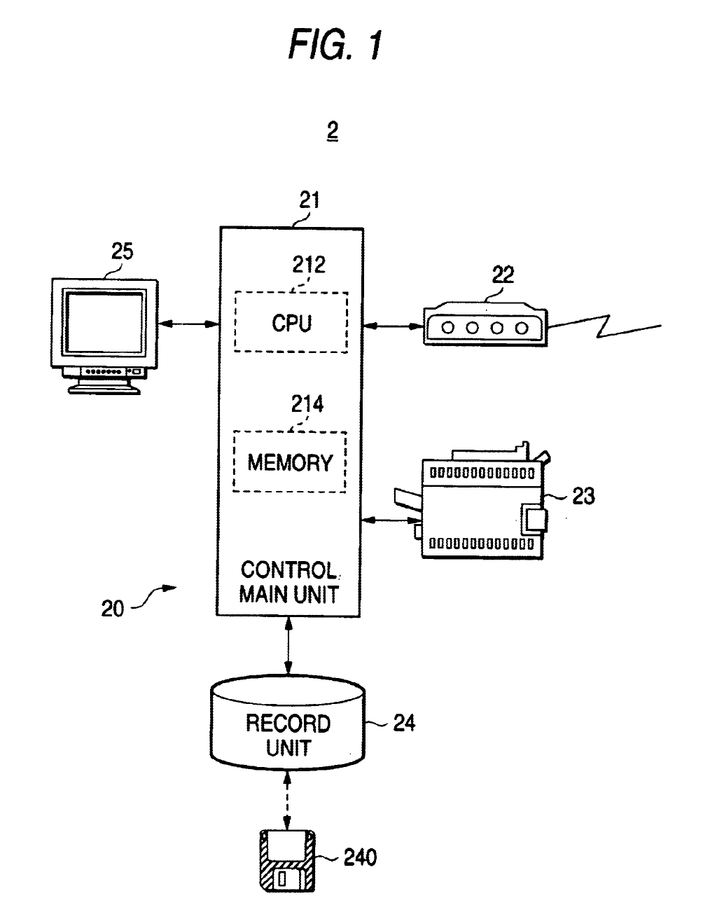

FIG. 1 is a drawing to illustrate the hardware configuration of a printer 2 (image formation apparatus) incorporating the image processing method according to the invention centering on a controller 20.

As shown in FIG. 1, the printer 2 is made up of the controller 20 and a printer main unit 23 (an output section). The controller 20 is made up of a controller main unit 21 including a CPU 212, memory 214, and the like, a communication unit 22, a record unit 24 such as an HDD or CD unit, and a user interface unit (UI unit) 25 including an LCD or a CRT display, a keyboard, a touch panel, and the like.

The printer 2 acquires image data through the communication unit 22, the record unit 24, or the like and controls a print engine (not shown) of the printer main unit 23 to print the image data.

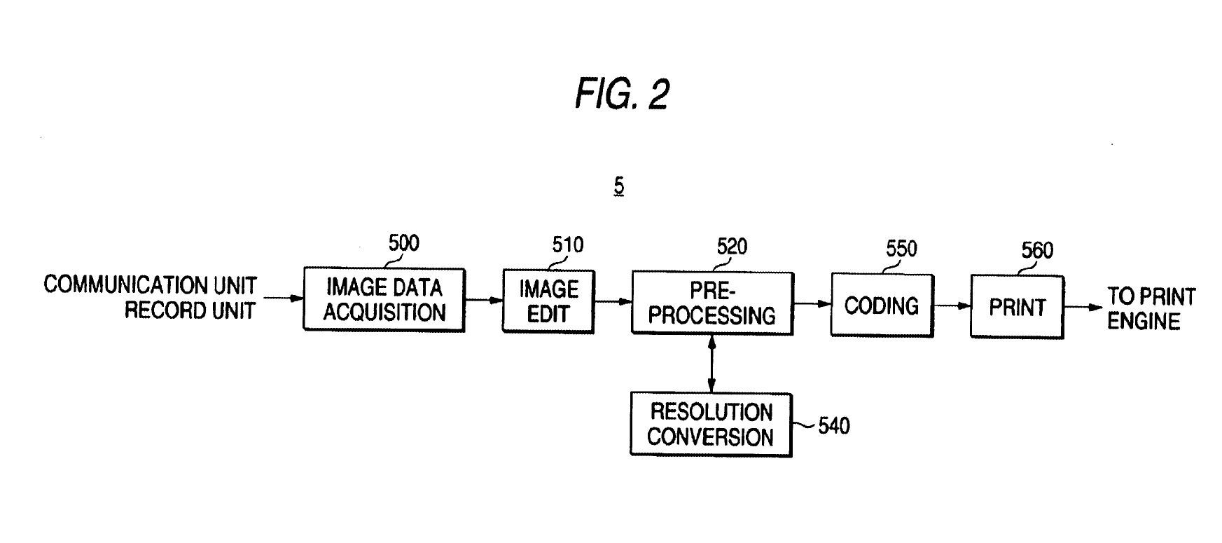

FIG. 2 is a diagram to show the configuration of an image formation program 5 executed by the controller 20 (FIG. 1) for realizing the image processing method according to the invention. As shown in FIG. 2, the image formation program 5 has an image data acquisition section 500, an image edit section 510, a preprocessing section 520, a resolution conversion section 540 (a scale-up section), a coding section 550, and a print section 560.

The image formation program 5 is supplied to the controller 20 via the record medium 240 (FIG. 1), for example, and is loaded into the memory 214 for execution.

The image data acquisition section 500 acquires image data to be printed through the communication unit 22 (FIG. 1) or the record unit 24 (FIG. 1) and outputs the image data to the image edit section 510.

The image edit section 510 performs processing of color conversion, rotation, tone conversion, etc., for the image data input from the image data acquisition section 500, and outputs the provided image data to the preprocessing section 520.

The resolution conversion section 540 changes the number of pixels of the image data in response to the resolution of the image data acquired by the image data acquisition section 500 and the print resolution of print executed by the print section 560. As means for changing the number of pixels, the resolution conversion section 540 performs interpolation processing (scale-up processing) for the image data subjected to preprocessing by the preprocessing section 520 to change the number of pixels. The resolution conversion section 540 in the example interpolates the pixels according to the Nearest Neighbor method in the two directions orthogonal to each other to scale up each pixel group.

The pixel interpolation method is not limited to the Nearest Neighbor method and may be a method for determining the pixel value of each interpolation pixel based on the peripheral pixels, such as a linear interpolation method, a three-dimensional interpolation method, or an area mean method.

The preprocessing section 520 performs preprocessing responsive to the coding processing technique for the image data input from the image edit section 510 and outputs the image data to the coding section 550. Preferably, the preprocessing section 520 changes the pixel values so as to raise the compression ratio and generates the data to be coded based on the provided pixel values. The preprocessing of the preprocessing section 520 corresponds to the coding method of the coding section 550 described later. For example, if the coding section 550 performs RLE coding, the preprocessing section 520 counts the successive number of the pixels having roughly the same pixel value and generates the data indicating the pixel value and the count; if the coding section 550 performs prediction coding, the preprocessing section 520 generates prediction data (prediction method identification data, prediction order identification data, prediction error, or the like).

The coding section 550 converts the image data input from the preprocessing section 520 into code data and outputs the code data to the print section 560.

The print section 560 decodes the code data input from the coding section 550 into image data and controls the print engine (not shown) of the printer main unit 23 (FIG. 2) to print an image.

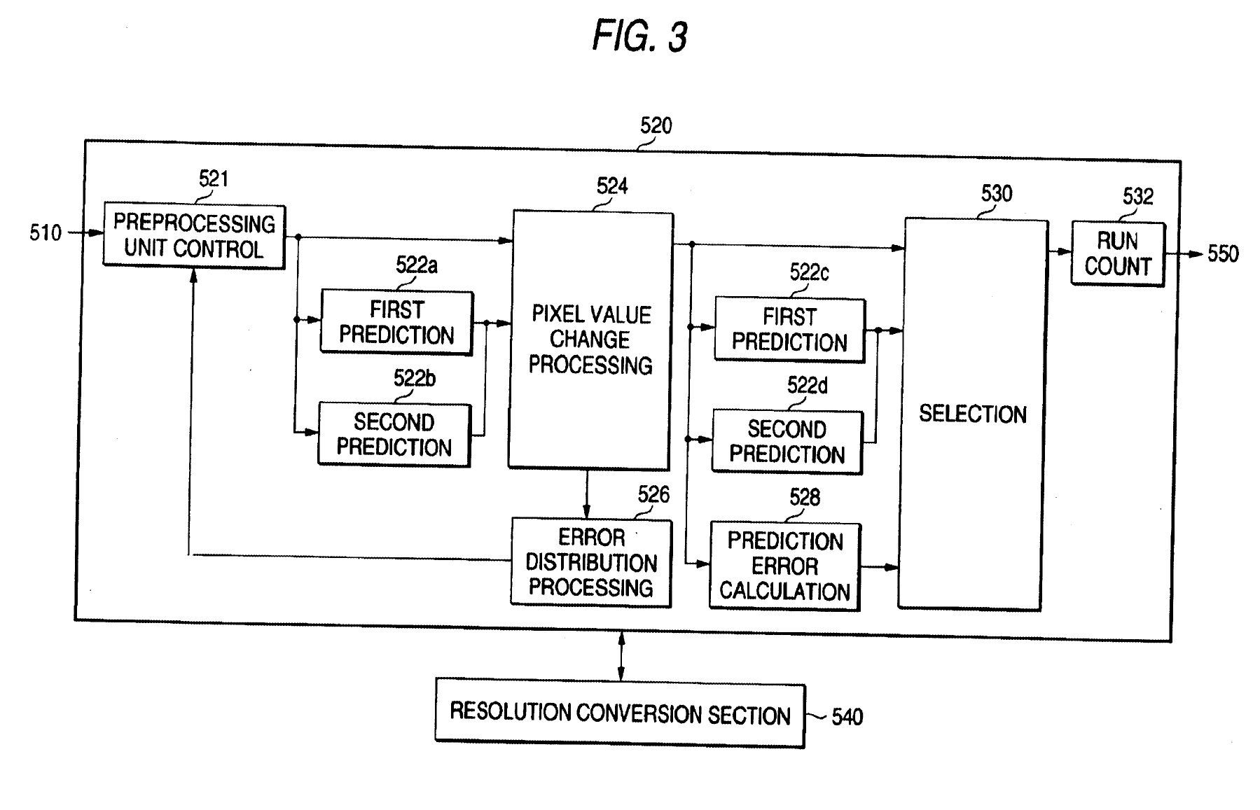

FIG. 3 is a diagram to describe the configuration of the preprocessing section 520 in more detail.

The preprocessing section 520 has a processing unit control section 521 (an acquisition section), a first prediction section 522a, a second prediction section 522b, a pixel value change processing section 524, an error distribution processing section 526, a first prediction section 522c, a second prediction section 522d, a prediction error calculation section 528, a selection section 530, and a run count section 532. In the example, prediction coding for two types of prediction sections (first and second prediction sections) to use different prediction methods to predict each pixel value will be discussed as a specific example, but the number of types of prediction sections may be one or more; for example, five types of prediction sections may be provided.

The processing unit control section 521 stores the image data input from the image edit section 510 and outputs the image data of a predetermined number of pixel groups (processing units) to the first prediction section 522a, the second prediction section 522b, and the pixel value change processing section 524. The processing unit is, for example, one line of an image, one image, a preset number of pixels, or the like. In the embodiment, one line of an image in the lateral direction thereof is taken as a specific example of the processing unit.

Each of the first prediction section 522a and the second prediction section 522b predicts the pixel value of the attention pixel based on the image data according to a predetermined technique. The first prediction section 522a and the second prediction section 522b generate a prediction value based on the image data input from the processing unit control section 521, and output the prediction value to the pixel value change processing section 524. The first prediction section 522c has substantially the same function as the first prediction section 522a, and the second prediction section 522d has substantially the same function as the second prediction section 522b. The first prediction section 522c and the second prediction section 522d receive the pixel value from the pixel value change processing section 524 and output a prediction value to the selection section 530.

In the example, the first prediction section 522a (522c) and the second prediction section 522b (522d) reference the pixel values of pixels at different positions and predict the pixel value of the attention pixel. The attention pixel is the pixel to be processed.

The pixel value change processing section 524 makes a comparison between the pixel value of the attention pixel and the prediction value. If the difference therebetween is smaller than a preset value, the pixel value change processing section 524 outputs the prediction value to the first prediction section 522c, the second prediction section 522d, the prediction error calculation section 528, and the selection section 530 and further outputs the difference between the pixel value of the attention pixel and the prediction value, which will be hereinafter referred to as error value, to the error distribution processing section 526. On the other hand, if the difference between the pixel value of the attention pixel and the prediction value is equal to or greater than the preset value, the pixel value change processing section 524 outputs the pixel value of the attention pixel intact to the first prediction section 522c, the second prediction section 522d, the prediction error calculation section 528, and the selection section 530 and outputs 0 to the error distribution processing section 526. That is, the preprocessing section 520 does not make error distribution of the error value equal to or greater than the preset value.

The error distribution processing section 526 generates an error distribution value based on the error value input from the pixel value change processing section 524, and adds the error distribution value to the pixel value of a predetermined pixel contained in the image data. The error distribution value is calculated by multiplying the error value by a weight matrix value according to an error diffusion method or a least mean error method using a weight matrix, for example.

The prediction error calculation section 528 predicts the pixel value of the attention pixel according to a predetermined prediction method, subtracts the prediction value from the actual pixel value of the attention pixel, and outputs the result to the selection section 530 as the prediction error value. The prediction method of the prediction error calculation section 528 may correspond to the prediction method of a decoding unit for decoding code data. In the example, the prediction error calculation section 528 generates a prediction value according to the same prediction method as the first prediction section 522 and calculates the difference between the prediction value and the actual pixel value.

The selection section 530 detects match or mismatch of the prediction in the attention pixel from the actual pixel value and the prediction value. If the first or second prediction section 522a or 522b makes right prediction as the result of the detection, the selection section 530 outputs the identification number of the prediction section 522 making the right prediction to the run count section 532 and the coding section 550; if neither the first nor the second prediction section 522 makes right prediction, the selection section 530 outputs the prediction error value to the run count section 532 and the coding section 550.

The run count section 532 counts the successive number of occurrences of the same identification number and generates the coded data indicating the identification number and the successive number. If the prediction error value is input, the run count section 532 outputs the input prediction error value to the coding section 550 as coded data.

For example, to count the number of runs of the first prediction section, if the identification number indicates the first prediction section 522c, the run count section 532 increments an internal counter by one. If the identification number does not indicate the first prediction section 522c and the internal counter is not 0, the run count section 532 outputs the value of the internal counter to the coding section 550 as the run data. In the example, if the run data and the prediction error value are given at the same time, the coding section 550 first codes the run data and then codes the prediction error value. On the other hand, if only the identification number or the prediction error value is given, the coding section 550 codes the identification number or the prediction error value.

The coding processing of the run count section 532 and the coding section 550 is a mode assuming that the hit probability of the first prediction section 522c is high, but any other coding method may be used. For example, if fixed-length code is given for the purpose of high-speed decoding, etc., the coding section 550 codes a signal indicating that the first prediction section 522c makes right prediction as binary number “01,” a signal indicating that the second prediction section 522d makes right prediction as binary number “10,” or a signal indicating that neither the first nor the second prediction section makes right prediction as binary number “00,” and codes the prediction error as code plus eight-bit binary number. To enhance the compression ratio, the coding section 550 may code using variable-length coding such as arithmetic coding. For example, for Huffman code with one-bit code given to the first prediction section 522c where the occurrence probability seems to be high, the coding section 550 codes a signal indicating that the first prediction section 522c makes right prediction as binary number “00,” a signal indicating that the second prediction section 522d makes right prediction as binary number “10,” or a signal indicating that neither the first nor the second prediction section 522 makes right prediction as binary number “11.” The coding section 550 may code using arithmetic coding. Thus, several coding techniques are possible.

Thus, the preprocessing section 520 in the embodiment changes the pixel values contained in the image data so that the coding section 550 easily compresses the image data. At the time, the preprocessing section 520 distributes the difference from the true pixel value produced by changing the pixel value to the peripheral pixels for making the pixel value change macroscopically inconspicuous.

Next, the general operation is as follows:

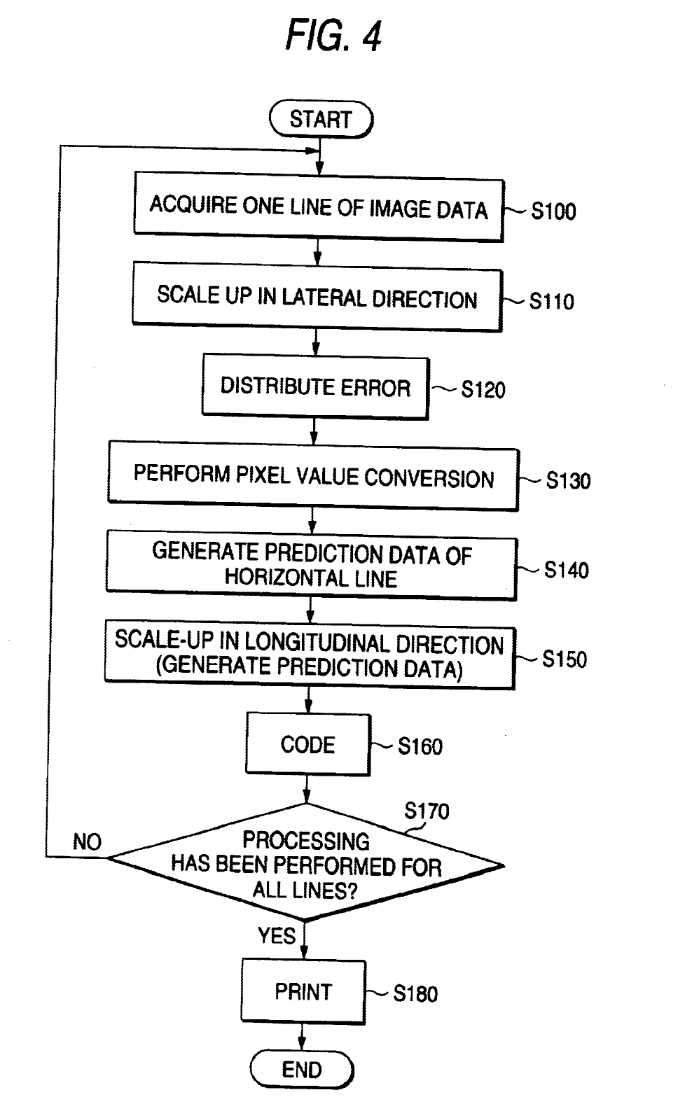

FIG. 4 is a flowchart to show first operation (S10) of the printer 2 (image formation program 5).

As shown in FIG. 4, at step 100 (S100), when the image data acquisition section 500 acquires image data through the communication unit 22 or the record unit 24, the image edit section 510 performs edit processing of color conversion, etc., for the acquired image data, and outputs the image data to the preprocessing section 520. The processing unit control section 521 in the preprocessing section 520 stores the image data input from the image edit section 510 and then outputs the image data of one line (attention line) to the resolution conversion section 540.

It is desirable that the image data output by the processing unit control section 521 should be a raster image. If a vector image is input, the processing unit control section 521 converts the vector image into a raster image and outputs the raster image to the prediction sections 522, etc.

At step 110 (S110), the resolution conversion section 540 interpolates pixels into the image data on the attention line input from the processing unit control section 521 in the lateral direction to scale up the pixel group in the lateral direction. The resolution conversion section 540 outputs the image data of the pixel group after being scaled up to the processing unit control section 521.

At step 120 (S120), the processing unit control section 521 adds the error value of the preceding line (line preceding the attention line) input from the error distribution processing section 526 to the pixel values of the attention line and outputs the resultant pixel values to the first prediction section 522a, the second prediction section 522b, and the pixel value change processing section 524.

At step 130 (S130), the first prediction section 522a outputs the pixel value of the pixel just to the left of the attention pixel for the image data of the input attention line to the pixel value change processing section 524 as the prediction value, and the second prediction section 522b outputs the pixel value of the pixel just above the attention pixel for the image data of the input attention line to the pixel value change processing section 524 as the prediction value. The error distribution processing section 526 makes a comparison between the pixel value of the attention pixel in the pixel group of the input attention line and each of the prediction values input from the first prediction section 522a and the second prediction section 522b. If the difference is equal to or greater than a preset value, the error distribution processing section 526 outputs the pixel value of the attention pixel to the first prediction section 522c, the second prediction section 522d, the prediction error calculation section 528, and the selection section 530. If the difference between the pixel value and either prediction value is less than the preset value, the error distribution processing section 526 outputs the prediction value whose difference from the pixel value of the attention pixel is within the preset value to the first prediction section 522c, the second prediction section 522d, the prediction error calculation section 528, and the selection section 530 and also outputs the difference between the pixel value of the attention pixel and the prediction value (error value) to the error distribution processing section 526. The error distribution processing section 526 outputs the error value input from the pixel value change processing section 524 to the processing unit control section 521 to distribute the error value to the pixels of the next line.

At step 140 (S140), the first prediction section 522c outputs the pixel value at the same position as for the first prediction section 522a to the selection section 530 as the prediction value, and the second prediction section 522d outputs the pixel value at the same position as for the second prediction section 522d to the selection section 530 as the prediction value. The prediction error calculation section 528 calculates the difference between the pixel value input from the pixel value change processing section 524 and the pixel value of the pixel just to the left of the pixel (prediction value) and outputs the difference to the selection section 30. If the prediction value input from the first prediction section 522c or the second prediction section 522d matches the pixel value input from the pixel value change processing section 524, the selection section 530 outputs the identification number of the prediction section 522 outputting the match prediction value to the run count section 532; otherwise, the selection section 530 outputs the difference input from the prediction error calculation section 528 to the run count section 532 as the prediction error value.

If the same identification number is input successively, the run count section 532 counts the run number of the identification number (successive number). The run count section 532 collects the identification number and its run number and the prediction error value as prediction data about the attention line.

At step 150 (S150), the resolution conversion section 540 interpolates pixels in the longitudinal direction based on the prediction data provided by the run count section 532 to scale up the pixel group in the longitudinal direction. Since the coding section 550 in the example performs prediction coding of referencing the pixel just above and predicting the pixel value, the resolution conversion section 540 generates prediction data for referencing the attention line (data indicating reference to the pixel just above) and interpolates pixels just below the attention line. Next, the resolution conversion section 540 outputs the prediction data after interpolated in the longitudinal direction through the run count section 532 to the coding section 550.

At step 160 (S160), the coding section 550 converts the prediction data input from the run count section 532 into code data and outputs the code data to the print section 560.

At step 170 (S170), the image formation program 5 determines whether or not the processing has been performed for all lines. If the processing has been performed for all lines, the image formation program 5 completes the processing; otherwise, the image formation program 5 repeats steps S100 to S160.

At step 180 (S180), the print section 560 decodes the code data input from the coding section 550 for each line to generate print data, and controls the printer main unit 23 to print an image.

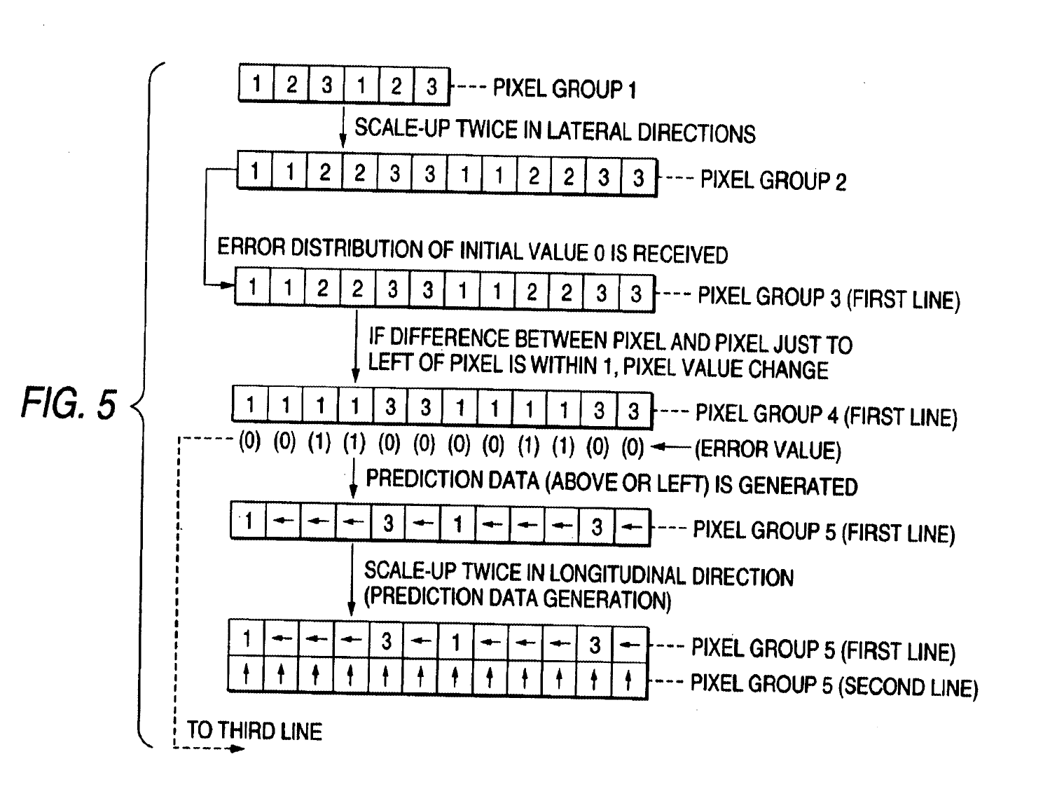

FIG. 5 is a drawing to describe change in pixel data as the preprocessing and the scale-up processing shown in the flowchart of FIG. 4 are performed.

In the figure, “pixel group 1” indicates the pixels of the attention line acquired by the processing unit control section 521 at S100, and the numeric values in “pixel group 1” indicate the pixel values of the pixels making up the attention line. One pixel is interpolated into each pixel in “pixel group 1” in the lateral direction by the resolution conversion section 540 at S110 to form “pixel group 2.” Next, each pixel in “pixel group 2” receives distribution of the error value occurring on the line just above “pixel group 2” to form “pixel group 3.” The attention line is the first line and distribution of the error value is 0.

The pixel value of each pixel in “pixel group 3” is changed by the pixel value change processing section 524 in response to the difference between the pixel value of the pixel and the pixel value of the pixel just to the left of the pixel to form “pixel group 4.” “Pixel group 4” is converted into prediction data by the selection section 530 and the run count section 532 to form “pixel group 5.”

To interpolate pixels into the prediction data of the attention line in the longitudinal direction, the resolution conversion section 540 generates prediction data “pixel group 5 (second line)” indicating reference to the attention line.

Thus, the printer 2 in the embodiment performs the preprocessing for the image data into which pixels have been interpolated in the lateral direction (pixel arrangement direction of a line) and interpolates pixels into the image data after subjected to the preprocessing in the longitudinal direction, whereby error value distribution processing and pixel value change processing can be skipped for the interpolation line in the longitudinal direction (second line). Further, to use an interpolation method wherein the interpolation line (second line) becomes almost the same image data as the line into which pixels are interpolated (first line), if the error value is distributed to the interpolation line (second line), the compression ratio may be lowered; however, the printer 2 in the example does not distribute the error value to the interpolation line (second line), so that the interpolation line (second line) becomes almost the same pixel values as the line into which pixels are interpolated (first line) and a high compression ratio can be provided.

Since the upward reference coding technique is used in the example, the prediction data of the interpolation line (second line) is only the data indicating reference to the pixel just above, and the compression ratio is raised. If the interpolating direction and the reference direction in the prediction coding (reference direction in the second prediction section 522d) thus match, the compression ratio of the interpolation line is raised and thus the embodiment is more preferable.

In the embodiment, the preprocessing is performed for the image data into which pixels have been interpolated in the lateral direction and after the preprocessing is performed, interpolation processing (scale-up processing) is performed in the longitudinal direction. That is, in the example, before the preprocessing is performed, the scale-up processing is performed in one of the interpolating directions, and the scale-up processing is performed only in another interpolating direction after the preprocessing is performed. However, the scale-up processing may be performed in every interpolating direction after the preprocessing is performed.

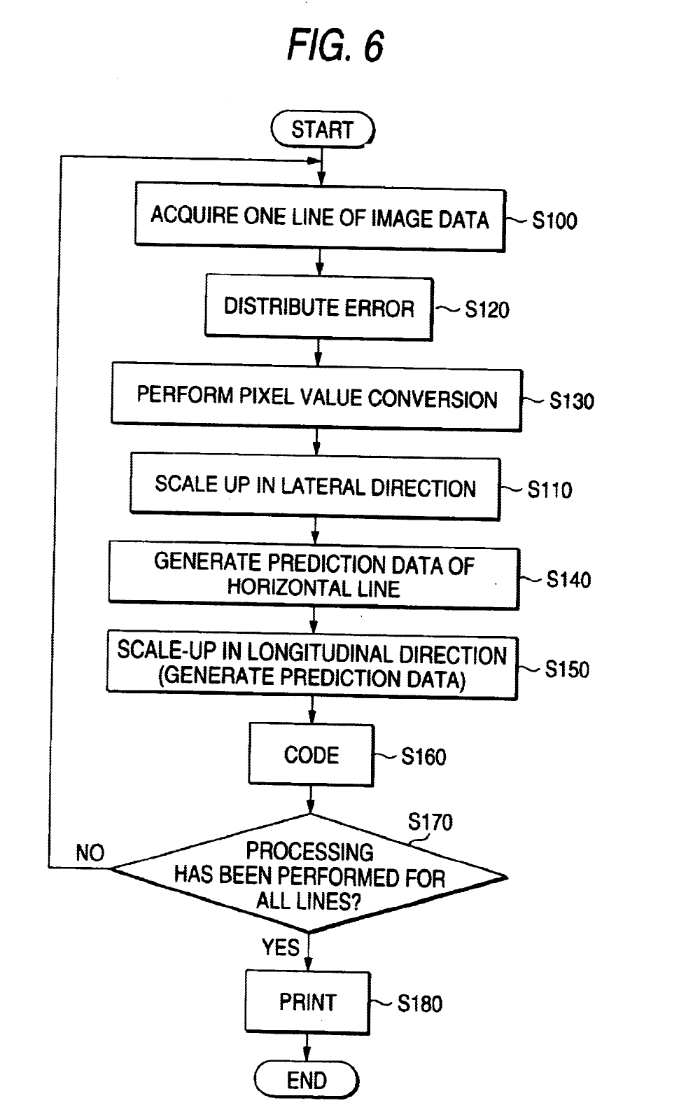

FIG. 6 is a flowchart to show second operation (S12) of the printer 2 (image formation program 5). Steps substantially identical with those previously described with reference to FIG. 4 are denoted by the same reference numerals in FIG. 6.

As shown in FIG. 6, the image formation program 5 in the example acquires image data of one line (S100), distributes the error value occurring on the preceding line (S120), and changes the pixel values (S130) and then at S110, the resolution conversion section 540 interpolates pixels into the image data of one line in the lateral direction to scale up the pixel group.

At step 140 (S140), the preprocessing section 520 converts the image data of one line into prediction data and outputs the prediction data to the resolution conversion section 540.

At step 150 (S150), the resolution conversion section 540 generates prediction data indicating reference to the just above line as interpolation data for interpolating in the longitudinal direction.

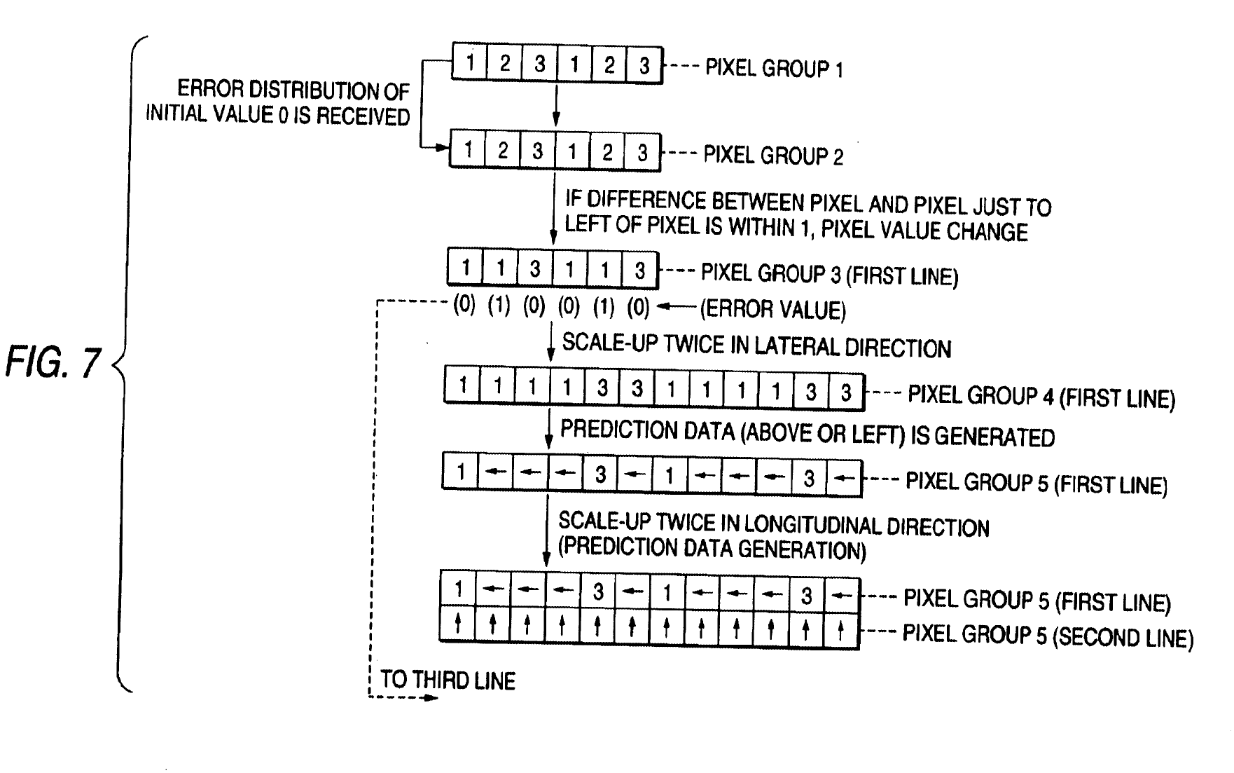

FIG. 7 is a drawing to describe change in pixel data in the preprocessing and scale-up processing shown in FIG. 6.

In the figure, “pixel group 1” indicates the pixels of the attention line acquired by the processing unit control section 521 at S100, and the numeric values in “pixel group 1” indicate the pixel values of the pixels making up the attention line. Each pixel in “pixel group 1” receives distribution of the error value occurring on the line immediately preceding “pixel group 1” to form “pixel group 2.” The attention line is the first line and distribution of the error value is 0.

The pixel value of each pixel in “pixel group 2” is changed by the pixel value change processing section 524 to form “pixel group 3.”

One pixel is interpolated into each pixel in “pixel group 3” in the lateral direction by the resolution conversion section 540 at S110 to form “pixel group 4.”

“Pixel group 4” is converted into prediction data by the selection section 530 and the run count section 532 to form “pixel group 5.”

To interpolate pixels into the prediction data of the attention line in the longitudinal direction, the resolution conversion section 540 generates prediction data “pixel group 5 (second line)” indicating reference to the attention line (the first line of “pixel group 5”).

Thus, according to the printer 2 in the modification, error distribution in the preprocessing and pixel value change processing are performed and then pixels are interpolated in the lateral direction and the longitudinal direction, whereby error distribution processing and pixel value change processing can be skipped for all interpolation lines and it is made possible to decrease the processing load.

In the embodiment, the scale-up processing is performed after the error distribution processing, whereby a decrease in the processing load of the error distribution processing, etc., is accomplished. However, the error distribution processing section 526 may distribute the error value to the pixel at the position responsive to the interpolation amount of the resolution conversion section 540 so as to distribute the error value skipping the pixel generated by the scale-up processing. In this case, the prediction data of the interpolation line needs to indicate reference to the line to which the error value is distributed. Accordingly, the processing load of the error distribution processing does not grow regardless of which of the scale-up processing and the error distribution processing is first performed.

For example, in the embodiment, if the resolution conversion section 540 converts the resolution into n times the resolution (interpolates n pixels into each pixel), the error distribution processing section 526 distributes the error value to the pixel of the line preceding n lines.

The position to which the error value is distributed is thus changed in response to the interpolation amount, whereby the image formation program 5 can be designed without considering the preceding and following relationship between the error distribution processing and the scale-up processing.

In the embodiment, the resolution conversion section 540 performs the scale-up processing for the image data after subjected to the preprocessing and before being coded, but may perform scale-up processing of scaling up the pixel group for the image data coded by the coding section 550.

As described above, the image processing apparatus according to the invention makes it possible to decrease the processing load in the processing sequence including the image scale-up processing and compression processing.

What is claimed is:

1. An image processing apparatus comprising:
a coding section for coding image data of a pixel group including a predetermined number of pixels; and
a scale-up section for scaling up the pixel group based on the image data coded by the coding section.

2. The image processing apparatus according to claim 1, further comprising:
a preprocessing section for performing preprocessing for coding for image data of the pixel group, wherein
the scale-up section scales up the pixel group based on the image data subjected to the preprocessing by the preprocessing section; and
the coding section codes the image data of the pixel group scaled up by the scale-up section.

3. The image processing apparatus according to claim 2, wherein:
the preprocessing section includes a pixel value change section for changing the pixel value of an attention pixel on which attention is focused as the processing target based on the pixel value of the attention pixel and the pixel values of peripheral pixels of the attention pixel;
the scale-up section scales up the pixel group based on the pixel value provided by the pixel value change section; and
the coding section codes the image data of the pixel group scaled up by the scale-up section.

4. The image processing apparatus according to claim 3, wherein:
the preprocessing section further includes a distribution section for distributing the change amount of the pixel value provided by the pixel value change section to another pixel;
the scale-up section accepts the pixel value distributed by the distribution section and further scales up the pixel group based on the pixel value provided by the pixel value change section; and
the coding section codes the image data of the pixel group scaled up by the scale-up section.

5. The image processing apparatus according to claim 2, wherein:
to code the image data of the attention pixel, the preprocessing section references the pixel value of the peripheral pixel of the attention pixel and coverts the pixel value of the attention pixel into data to be coded; and
the coding section codes the data to be coded, provided by the preprocessing section.

6. The image processing apparatus according to claim 5, wherein
the direction in which the scale-up section scales up the pixel group matches the referencing direction of the coding section.

7. An image processing apparatus comprising:
a scale-up section for scaling up a pixel group including a predetermined number of pixels;
a pixel value change section for changing the pixel values of the pixel group;
a distribution section for distributing the change amount of the pixel value provided by the pixel value change section to another pixel group; and
a coding section for accepting the pixel value distributed by the distribution section and coding the image data of the pixel group based on the pixel values provided by the pixel value change section, wherein
the scale-up section scales up the pixel group to which the pixel values have been distributed by the distribution section at least in one direction.

8. The image processing apparatus as according to claim 1, further comprising:
an input section; and
an acquisition section for acquiring the image data corresponding to one row of a pixel group forming a part of an image as a processing unit from image data input through the input section, wherein:
the coding section codes the image data for each processing unit acquired by the acquisition section; and
the scale-up section scales up the pixel group for each processing unit acquired by the acquisition section.

9. The image processing apparatus according to claim 1, further comprising
an output section for decoding the image data coded by the coding section and outputting the provided data.

10. The image processing apparatus according to claim 1, further comprising
an error value distribution section for distributing error value in a longitudinal direction of a pixel arrangement direction of a line, wherein
a position to which the error value is distributed is decided based on the scaring up ratio.

11. The image processing apparatus according to claim 10, wherein
the position is a front line of the line scaled up.

12. The image processing apparatus according to claim 10, further comprising
a resolution conversion section for converting a resolution, wherein
if the resolution conversion section converts the resolution into n times the resolution, the error value distribution section distributes the error value to the pixel of the line preceding n lines.

13. An image processing method comprising:
coding image data of a pixel group including a predetermined number of pixels; and
scaling up the pixel group based on the coded image data.

14. The image processing method according to claim 13, further comprising:
performing preprocessing for coding for image data of the pixel group, wherein
the scaling up of the pixel group scales up the pixel group based on the image data subjected to the preprocessing by the performing preprocessing; and
the coding of image data of the pixel group codes the image data of the pixel group scaled up by the scaling up of the pixel group.

15. The image processing method according to claim 14, wherein:
the performing of preprocessing includes changing the pixel value of an attention pixel on which attention is focused as the processing target based on the pixel value of the attention pixel and the pixel values of peripheral pixels of the attention pixel;
the scaling up of the pixel group scales up the pixel group based on the pixel value provided by the changing of the pixel value of the attention pixel; and
the coding of image data of the pixel group codes the image data of the pixel group scaled up by scaling up of the pixel group.

16. The image processing method according to claim 15, wherein:
the performing of preprocessing further includes distributing the change amount of the pixel value provided by the changing of the pixel value of the attention pixel to another pixel;
the scaling up of the pixel group accepts the pixel value distributed by the distributing the change amount of the pixel value and further scales up the pixel group based on the pixel value provided by the changing of the pixel value of the attention pixel; and
the coding of image data of the pixel group codes the image data of the pixel group scaled up by the scaling up of the pixel group.

17. The image processing method according to claim 14, wherein:
to code the image data of the attention pixel, the performing of preprocessing references the pixel value of the peripheral pixel of the attention pixel and coverts the pixel value of the attention pixel into data to be coded; and
the coding of image data of the pixel group codes the data to be coded, provided by the performing of preprocessing.

18. The image processing method according to claim 17, wherein
the direction in which the scaling up of the pixel group scales up the pixel group matches the referencing direction of the coding of image data of the pixel group.

19. An image processing method comprising:
scaling up a pixel group including a predetermined number of pixels;
changing the pixel values of the pixel group;
distributing the change amount of the pixel value provided by the changing of the pixel values of the pixel group to another pixel group; and
accepting the pixel value distributed by the distributing of the change amount of the pixel value and coding the image data of the pixel group based on the pixel values provided by the changing of the pixel values of the pixel group, wherein
the scaling up of a pixel group scales up the pixel group to which the pixel values have been distributed by the distributing of the change amount of the pixel value at least in one direction.

20. A program executable by a computer for an image processing apparatus including the computer, the program comprising:
coding image data of a pixel group including a predetermined number of pixels; and
scaling up the pixel group based on the coded image data.
